(19) United States
(12) Patent Application Publication
(10) Pub. No.: US 2024/0374088 A1
(43) Pub. Date: Nov. 14, 2024

(54) HAND-SHOWER GLOVE WITH BELTS

(71) Applicant: Alain Gabin RATIN, Martinique (FR)

(72) Inventor: Alain Gabin RATIN, Martinique (FR)

(21) Appl. No.: 18/286,362

(22) PCT Filed: Apr. 14, 2022
(86) PCT No.: PCT/FR2022/000031

§ 371 Date: Oct. 10, 2023

(30) Foreign Application Priority Data
Apr. 15, 2021 (FR) FR2103929

(51) Int. Cl. A47K 7/02; A41D 19/00

(52) U.S. Cl. CPC A47K 7/02; A41D 19/0024

(57) ABSTRACT

The invention relates to a washing implement of the shower glove type in which the hand shower is joined to the user's fingers by a finger belt (4), and to their wrist by a wrist belt (10); the shower heads are provided with a tail (16) which passes under the plate (1) and which is fixed to the inlet hose of the shower head; the height of the shower heads with respect to the plane rubbed by the fingers is adjusted with the aid of joints (15) to be fitted on the threaded stems of the rings, under the plate (1); the rings are secured entirely or partially to the plate by nuts (14) screwed onto the threaded stems (6) above the plate.

### THE FIELD OF USE AND PRIOR ART

By definition—see the previous patent FR1800462—we call “glove-shower” a “toilet utensil used in the cleaning of the human epidermis, composed of a rubbing glove on which it is fixed, by mechanical and/or chemical connection, a flexible hand shower”—; the terms “tray”, “shower-head” “ring”, “buttonhole” have the same meaning here as in the said patent FR1800462.

In the present model, called “with belts”, the connection used to attach the hand shower to the user's glove and hand is made by the two belts outside the glove:
One, the “digital belt”, which connects the hand shower to the fingers of the glove and to those of the user;
The other, the “wristband belt”, which connects the shower tray to the user's wrist. The shower glove with belts has at least three advantages with comparison to the previous model described in patent FR1800462:
The hand shower can be installed on a bare hand, be held in the hand, or be attached to any support; it can, if necessary, replace a conventional hand shower;
The shower heads are movable laterally on the tray and are held between the fingers of the user thanks to a digital belt which straddles an appendage of the lower part of the shower-head, called here the “tail of the shower-head”,
To adjust, to the nearest mm, the height of the shower-heads in relation to the plane rubbed by his fingers, the user can insert “adjustment joints” on a threaded rod that rises in the center of the rings; finally, a nut screwed onto said threaded rod allows the user to fully or partially secure the ring to the tray.

### THE DISCLOSURE OF THE INVENTION

The device includes:
A tray (1) on which the two shower-heads rest (2); the said tray is provided with three buttonholes (5) where the threaded rods (6) of the rings (7) will be inserted, four side eyelets (8) where two loops (3)—thin elastic ribbons—where the digital belt will pass will be fixed (4), and two central eyelets (9) where the thin elastic ribbon loop of the bracelet belt (10) will be fixed; top thickness: 1.5 mm; width: 24 mm; length: 86 mm;
The digital belt (4), composed of a ribbon, partly elastic, one of the two ends of which is provided with a buckle (11) and the other end of which (12), can be secured by the said buckle (11); belt width: 20 mm;
The wristband belt (10), one end of which includes the loop-sewn(13) of the slipknot where the user's wrist will be introduced, and the other end of which will be looped—Velcro connection—around the central loop of the tray;
Three rings (7) fitted with their threaded rods (6), three nuts (14), and six adjustment joints (15) including three 2 mm and three 4 mm thick;
Two shower-heads (2) whose lower part furnished with holes is extended by a “tail”, appendage comprising a part not carrying holes, terminated by an eyelet (17), and a lace (16) whose one end is attached to the eyelet (17) and the other end to the inlet pipe of the shower-head by a knot (1 8); the tip of the shower-head is raised so that it does not scratch in the case of tilting of the shower-head forward; shower-head thickness: about 6 mm in the lower part; outside diameter of shower-head inlet: 6 mm;
Two short pipes (20)—length approximately 10 cm—diameters 6 and 8 mm;
A three-way connector (21); Another short pipe (22)—about 20 cm—one end of which is connected to the inlet of the three-way connector and the other to a simple connector (23) for, if necessary, the changes of users of the same source of liquid;
Finally, a long pipe (24)—about 100 cm—connecting the connector (23) to the common source of cleaning liquid—tap, tank—.

### DESCRIPTION OF AN EMBODIMENT

The elements of the “belt shower glove” described above, supplied by the manufacturer, will be assembled as follows by the user:
To attach the two shower-heads to the tray; for that, to insert, at mid-length, one of the ends of the lace (16) of the “tail of the shower-head”, into the eyelet (17); to join the two ends of the lace, twist it and pass it under the tray then go up vertically by tightening the edge of the tray; then separate the two ends of the lace and tie them at the top of the inlet pipe of the shower-head,—node (18)—; the part of the shower-heads which is provided with holes is extended by an appendix, called “tail of the shower-head”, formed of a tapered part, not filled with holes, and which, in the whole device, continues horizontally under the tray (1), rises vertically by tightening the edge of the tray, and is fixed, by a reversible mechanical connection,—(18)—to the inlet pipe of the shower-head, said shower-head thus forms a closed loop around the tray; not to pull too much on the laces (16) because the shower-heads must be able to slide laterally, without too much friction, on the tray; to install the two side loops (3) of the digital belt and the central loop of the bracelet belt in the same way;
To place the rings (7) under the tray (1) by inserting the threaded rods (6) into their slots (5), then to screw the nuts (14) onto the threaded rods above the tray, leaving some play so that the rings can slide and turn under the tray. Then to place the assembly thus obtained on the first phalanges of the fingers (i) (a) and (m)—index, ring finger and middle finger—of the user and to note the distance of the holes of the shower-heads in relation to the plane rubbed by the fingers, taking into account the thickness of the glove: if this distance is between 0 and 6 mm, then adjustment gaskets, 2 mm and 4 mm thick, can be used, by inserting these gaskets on the threaded rods of the rings, under the tray, to bring the said altitude to an ideal value close to 6 mm, to within 1 mm; by inserting a joint (15) under the tray, on at least two of the threaded rods, the tray and therefore the shower-heads are raised by the same amount, with respect to the plane rubbed by the fingers; otherwise,—shower-heads too high or too low—choose another size of shower-heads and if necessary another size of tray; the characteristics of the elements of the device will be, at first, adapted to the morphology of typical users in each country; the pre-adjustment is done when purchasing the device; finally secure the rings to the tray, in fixed mode or in mobile mode—recommended mode—by tightening the nuts more or less tightly (14).
To position the digital belt correctly so that it can be buckled without twisting above the tray, the buckle being on the side of the ring finger; to seize the rounded end (12) of said belt and make it follow the path (19):
first downwards, between the two ribbons of the loop (3) on the annular side (a);
then, continuing under the tray, above the tails of the two shower-heads,
and finally upwards in the loop (3) on the index side (i);
Then to pull on the rounded end of the digital belt to bring the buckle (11) close to (a), leaving three wide ribbon loops (25) under the rings of (i) (m) and (a) to facilitate the passage of the user's fingers, then to buckle the belt above the tray; the hand shower comprises a belt (4) of which a part passes under the tray by performing-path—(19)—from right to left of the tray, successively:
a loop (25) under the right ring,
a loop above the tail (16) of the right shower-head,
a loop under the middle ring,
a loop above the tail of the left shower-head,
finally, a loop under the left ring, the loops (25) under the rings being reserved for the user's fingers;
to connect the device supply hoses: short hoses, long hose and three-way connector;
Install the strap belt; correctly place the slip knot without forgetting the short pipe (22) or the long pipe (24); the strap belt simultaneously limits the sliding of the hand shower forwards, and the tilting of the shower head upwards;
To put on the glove—if necessary—; insert the hand, thumb bent, in the said slip knot of the bracelet belt, then choose the three fingers (i) (m) and (a)—index, middle finger and ring finger—or only the fingers (i) and (a), in the ribbon loops (25) of the digital belt; in the second case, the finger (m) must be placed under the ring of (m) so that the digital belt sits well on the tails of the shower-heads;
Finally, to adjust the length of the belts so that the hand shower can float and slide about 1 cm but without coming out of the fingers during use of the device; to do this, attach the bracelet belt to the central loop of the tray, then gradually to reduce the tension, initially non-zero, of the two belts, until the hand shower begins to float, like a watch on the wrist; the hand shower must not be perceived by the user, unless—but this is not recommended—, the latter has his fingers clenched on the shower-heads; during subsequent uses, the belt settings will be retained.

### THE OPERATION OF THE DEVICE

First, under normal conditions of use, the holes in the shower-heads are at the correct height, approximately—6 mm, the belts are adjusted, the user's hand is relaxed, the fingers are placed flat on a plane, the shower-heads are conveniently located between the user's knuckles; the ring of (m) is fixed and the length of the side buttonholes of the tray is such that the minimum distance between two neighboring rings is approximately 1 cm, this is approximately the width of the shower-heads on the tray; under these conditions, when the hand is relaxed, the fingers (i) (a) and (m) are placed under their respective rings and are therefore far enough apart—approximately 7 mm at the level of the first phalanges—for the liquid to exit from the shower-heads are clear and the spray is working properly; moreover, the shower-heads can only slide laterally on the tray because they are blocked in all their other possible movements—from bottom to top, from front to back, in pivoting on the tray—by the two belts and by the tray; under these conditions, when the inlet of the long pipe (24) is connected to a source of liquid, under positive pressure, whatever the position of the user's hand in space, the said liquid gushes out of his hand as in the attached figure and which represents a real prototype of the device in operation; the device can therefore be used, either by direct contact with the epidermis, or from a distance; in addition, the belts are only placed on the glove, but not tied to it, the hand shower can be installed, if necessary, directly on the fingers of the bare hand,—index, ring finger and middle finger or middle finger, ring finger and auricle if the index finger is not available—or be used as a removable shower head; Then, the digital belt is unbuckled, or moved aside, the user can, with his free hand, move aside a loop (3) and tighten or loosen a nut,—whose “ears” are profiled so that they do not touch the shower-head pipe—change an adjustment gasket . . . ; but we remind you that this device is designed first of all for individual use.

Finally, the user can, still with his free hand, change the adjustment of the belts as he would do with the strap of a watch; the advantages of the “shower glove with belts” mentioned above are therefore verified; conversely, experience shows that this new device also has the advantages of the previous model, continuity of the rubbing glove . . . —provided that the portion of tape which comes into contact with the epidermis is of the same material as the rest of the glove—rubbing fabrics with or without elastics—and that the elastic portion of the tape is above the tray.

To remove the hand shower it is enough, not to unbuckle the belts, which are at least partly elastic, but to simultaneously release the hand, thumb bent, from the slipknot of the wristband belt with the help of the other hand, and the fingers (i) (a) (m) from the loops (25) of the digital belt.

The device is recommended in the event of a water shortage, or to avoid the transmission of germs between users of common shower heads; the minimum water consumption, for a full shower, with soaping in “drop by drop” mode and rinsing at a moderate flow rate, is less than five liters, compared to fifty liters with a conventional hand shower.

### INDUSTRIAL APPLICATION AND FEASIBILITY

All the elements of this new device, including the two belts, the nuts, the seals, etc., can be manufactured and/or sewn in series; all the rigid parts—rings, tray, three-way connector . . . —will be, for example, in low density nylon, pipes in flexible PVC; the shower-heads must be smooth, rounded at the corners, relatively flexible on the side faces, more rigid in the bent part; for this, they can be made by blowing, in a thin layer—about 0.7 mm—in the lower part—to allow compression of the shower-head between the fingers, if necessary—, and thicker-about 1.5 mm—in the elbow to avoid bending of the shower-head; thickness of the shower-head at rest: about 6 mm near the first knuckles; the final assembly of the parts can be done manually as indicated above, by the user himself.

### PRESENTATION OF THE ANNEXED DRAWINGS

FIG. 1: figure for the abstract, the glove-shower in operation (photo drawing);

FIG. 2: the hand shower seen from below (photo drawing);

FIG. 3: some parts of the device: the tray with its three loops, a shower-head with its lace, a ring, a nut (14), an adjustment seal (15), the three-way connector (21);

FIG. 4: assembly of the digital belt.

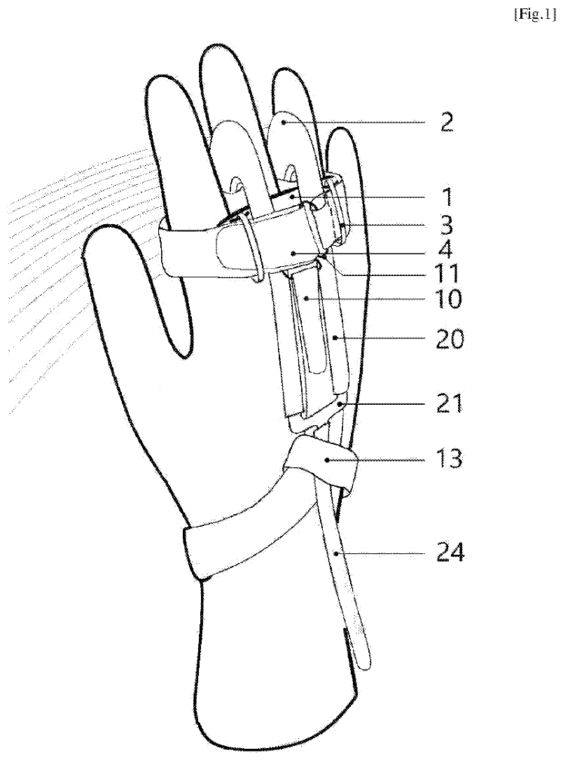

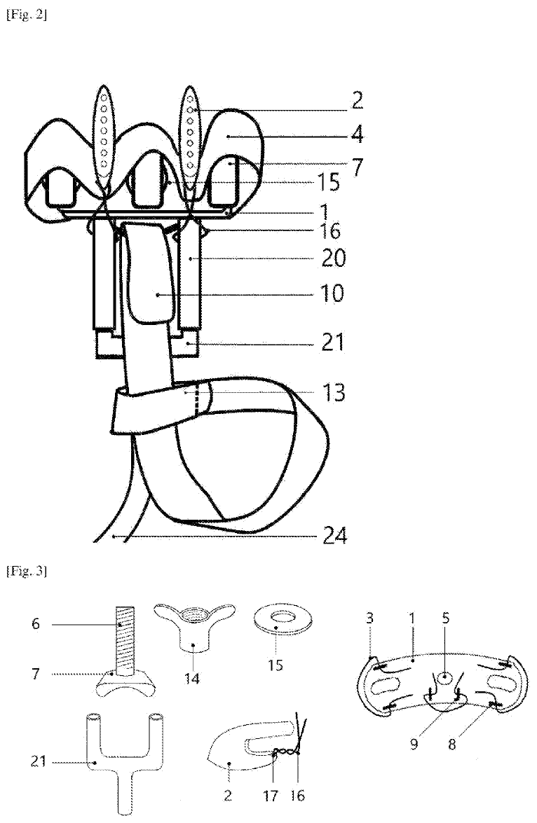

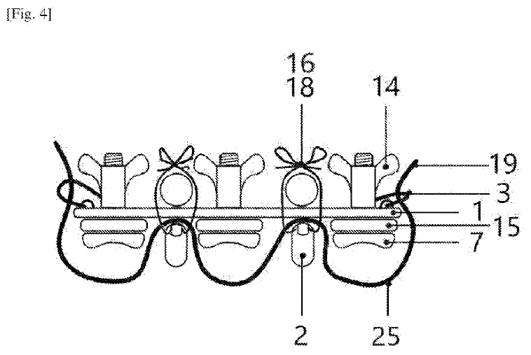

### DEFINITION BILL OF MATERIALS

(i), (a), (m): index, ring finger, middle finger;
(1) the tray;
(2) the two shower-heads;
(3) the side loops of the tray;
(4) digital belt;
(5) the three buttonholes on the tray;
(6) the threaded rods of the rings;
(7) the three rings;
(8) the four side eyelets of the tray;
(9) the two central eyelets of the tray;
(10) the bracelet belt;
(11) the buckle of the digital belt;
(12) the rounded end of the digital belt;
(13) the buckle of the slipknot of the bracelet belt;
(14) the three screws;
(15) 2 mm and 4 mm thick adjustment gaskets;
(16) the two laces of the shower-head tails;
(17) the eyelets at the back of the shower-heads;
(18) the knots of the laces of the shower-head tails;
(19) the path of the digital belt;
(20) the two small pipes;
(21) the three-way connector;
(22) the pipe between the three-way connector and the user change connector (23);
(23) the user switch fitting;
(24) the long pipe;
(25) the loops of tape around the first knuckles of the fingers (i), (a) and (m) of the glove;

1. Toilet utensil of the shower-glove type consisting of a rubbing glove on which is held a flexible spray nozzle which comprises:
a tray (1) provided with three buttonholes (5),
two shower-heads (2),
three rings (7),
Characterized in that the part of the shower-heads which is provided with holes is extended by an appendix, called “tail of the shower-head”, formed of a tapered part, not lined with holes, and which, in the whole device, continues horizontally under the tray (1), rises vertically by tightening the edge of the tray, and is fixed, by a reversible mechanical connection,—(18)—to the inlet pipe of the shower-head, said shower-head (2) thus forming a closed loop around the tray;

2. Device according to claim 1, characterized in that the hand shower comprises a belt (4) part of which passes under the tray by carrying out—path (19)—from right to left of the tray, successively:
a loop (25) under the ring (7) on the right,
a loop above the tail (16) of the shower-head (2) on the right,
a loop under the middle ring,
a loop above the tail of the left shower-head,
finally, a loop under the left ring, the loops (25) under the rings are reserved for the user's fingers;

3. Device according to claims 1 and 2, characterized in that the rings (7) of the hand shower are provided with threaded rods (6) which, during assembly of the hand shower, are inserted from bottom to top into the slots (5) of the tray, and on which the user can insert, under the tray, seals (15) with which he can adjust the height of the liquid outlet holes of the shower-heads with respect to the plane rubbed by his fingers.
